(19) United States
(12) Patent Application Publication
(10) Pub. No.: US 2023/0042500 A1
(43) Pub. Date: Feb. 9, 2023

(54) DISTRIBUTED VEHICLE COMPUTING

(71) Applicant: Ford Global Technologies, LLC, Dearborn, MI (US)

(72) Inventors: Jason Grix, Ferndale, MI (US); Elizabeth Grix, Ferndale, MI (US)

(73) Assignee: Ford Global Technologies, LLC, Dearborn, MI (US)

(21) Appl. No.: 17/392,545

(22) Filed: Aug. 3, 2021

(51) Int. Cl. H04L 9/32; H04L 9/06; G07C 5/00

(52) U.S. Cl. CPC H04L 9/3213; H04L 9/0643; G07C 5/008; H04L 2209/38

(57) ABSTRACT

A vehicle identifier and a nonfungible token (NFT) associated with the vehicle identifier are stored on an electronic ledger. The electronic ledger is a distributed electronic ledger shared between at least a computer and a remote computer. Upon transitioning a vehicle to an on state, the electronic ledger is queried to identify programming instructions associated with the NFT. Upon retrieving the identified programming instructions from the electronic ledger, the vehicle is actuated based on the retrieved programming instructions.

### BACKGROUND

Vehicles can be equipped with computers, networks, sensors, and/or controllers to acquire data regarding the vehicle's environment and/or to operate vehicle components. The computers typically may be programmed or reprogrammed via software updates, e.g., to update or modify an operation of the computer. Software updates are typically (although not necessarily) provided to the vehicle computer at least in part wirelessly, e.g., as over the air (OTA) updates. Software stored in vehicles can be lost or corrupted and can also be vulnerable to alteration.

### BRIEF DESCRIPTION OF THE DRAWINGS

FIG. 1A is a block diagram illustrating an example system to authorize a request to access programming instructions for a vehicle computer.

FIG. 1B is a block diagram illustrating an example blockchain network.

FIG. 2A is a block diagram illustrating an example response message.

FIG. 2B is a block diagram illustrating an example authorization message.

FIG. 2C is a block diagram illustrating an example request message.

FIG. 2D is a block diagram illustrating an example transfer message.

FIG. 2E is a block diagram illustrating an example access message.

FIG. 3 is an example of a blockchain ledger.

FIG. 4 is a flow chart of an example process for authorizing access to programming instructions.

### DETAILED DESCRIPTION

Vehicle computers may be communicatively coupled to one or more computing devices external to the vehicle computer, e.g., via a network. The one or more computing devices may permit the vehicle computer to access programming instructions for specified vehicle operations based on the vehicle computer being authorized, e.g., storing a nonfungible token associated with the programming instructions. In these circumstances, the programming instructions may alter data and/or settings stored in a memory of the vehicle computer to permit the vehicle computer to perform vehicle operations, e.g., actuating one or more vehicle components in a manner, specified by the programming instructions.

Advantageously, an electronic ledger provides programming instructions to authorized vehicle computers that cannot be accessed by unauthorized vehicle computers, which prevents unauthorized vehicle computers from altering the programming instructions and/or performing the vehicle operations specified by the programming instructions.

A system includes a computer including a processor and a memory, the memory storing instructions executable by the processor to store a vehicle identifier and a nonfungible token (NFT) associated with the vehicle identifier on an electronic ledger. The electronic ledger is a distributed electronic ledger shared between at least the computer and a remote computer. The instructions further include instructions to, upon transitioning a vehicle to an on state, query the electronic ledger to identify programming instructions associated with the NFT. The instructions further include instructions to, upon retrieving the identified programming instructions from the electronic ledger, actuate the vehicle based on the retrieved programming instructions.

The system can include the remote computer including a second processor and a second memory storing instructions executable by the second processor such that the remote computer is programmed to store the programming instructions associated with the NFT to the electronic ledger. The remote computer can be further programmed to, upon determining that the vehicle identifier is associated with the NFT, permit the computer to access the programming instructions associated with the NFT. The remote computer can be further programmed to, upon determining that the vehicle identifier is not associated with the NFT, prevent the computer from accessing the programming instructions associated with the NFT.

The remote computer can be further programmed to record in the electronic ledger a record that the NFT is transferred from the vehicle to another entity. The remote computer can be further programmed to upon recording the record, prevent the vehicle from accessing the programming instructions associated with the NFT. The record can include a request, from the other entity, for the NFT and a confirmation, from the computer, indicating that the NFT is transferred to the other entity.

The remote computer can be further programmed to record in the electronic ledger a record that the NFT is transferred from another entity to the vehicle. The remote computer can be further programmed to, upon recording the record, allow the vehicle to access the programming instructions associated with the NFT.

The programming instructions can include instructions to transition a vehicle component associated with the NFT between a disabled state and an enabled state.

The programming instructions can include instructions to actuate a projector in the vehicle to project image data associated with the NFT.

The programming instructions can include instructions to actuate a speaker in the vehicle to provide sound data associated with the NFT.

The programming instructions can include instructions to actuate a display in the vehicle to display a set of display content associated with the NFT.

The programming instructions can include instructions to actuate a vehicle component based on vehicle parameters associated with the NFT.

A system includes a vehicle computer including a processor and a memory, the memory storing instructions such that the vehicle computer is programmed to store a vehicle identifier and a nonfungible token (NFT) on an electronic ledger. The system further includes a remote computer including a second processor and a second memory, the second memory storing instructions such that the remote computer is programmed to store programming instructions associated with respective NFTs on the electronic ledger. The vehicle computer is further programmed to, upon transitioning a vehicle to an on state, query the electronic ledger to identify programming instructions associated with the NFT. The vehicle computer is further programmed to, upon retrieving the identified programming instructions, actuate the vehicle based on the identified programming instructions.

The remote computer can be further programmed to, upon determining that the vehicle identifier is associated with the NFT, permit the computer to access the programming instructions associated with the NFT. The remote computer can be further programmed to, upon determining that the vehicle identifier is not associated with the NFT, prevent the computer from accessing the programming instructions associated with the NFT.

The remote computer can be further programmed to record in the electronic ledger a record that the NFT is transferred from the vehicle to another entity. The remote computer can be further programmed to, upon recording the record, prevent the vehicle from accessing the programming instructions associated with the NFT.

The remote computer can be further programmed to record in the electronic ledger a record that the NFT is transferred from another entity to the vehicle. The remote computer can be further programmed to, upon recording the record, allow the vehicle to access the programming instructions associated with the NFT.

The programming instructions can include instructions to transition a vehicle component associated with the NFT between a disabled state and an enabled state.

The programming instructions can include instructions to actuate a projector in the vehicle to project image data associated with the NFT.

The programming instructions can include instructions to actuate a speaker in the vehicle to provide sound data associated with the NFT.

The programming instructions can include instructions to actuate a display in the vehicle to display a set of display content associated with the NFT.

The programming instructions can include instructions to actuate a vehicle component based on vehicle parameters associated with the NFT.

A method includes storing, via a vehicle computer, a vehicle identifier and a nonfungible token (NFT) on an electronic ledger. The method further includes storing, via a remote computer, programming instructions associated with respective NFTs on the electronic ledger. The method further includes, upon transitioning a vehicle to an on state via the vehicle computer, querying the electronic ledger to identify programming instructions associated with the NFT. The method further includes, upon retrieving the identified programming instructions, actuating, via the vehicle computer, the vehicle based on the identified programming instructions.

Further disclosed herein is a computing device programmed to execute any of the above method steps. Yet further disclosed herein is a computer program product, including a computer readable medium storing instructions executable by a computer processor, to execute an of the above method steps.

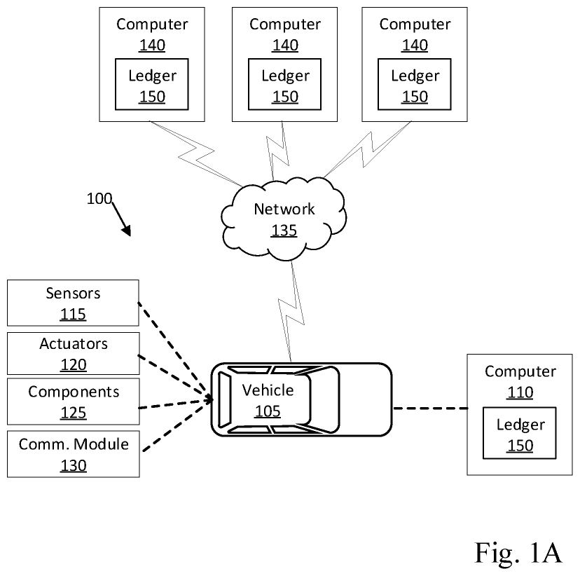

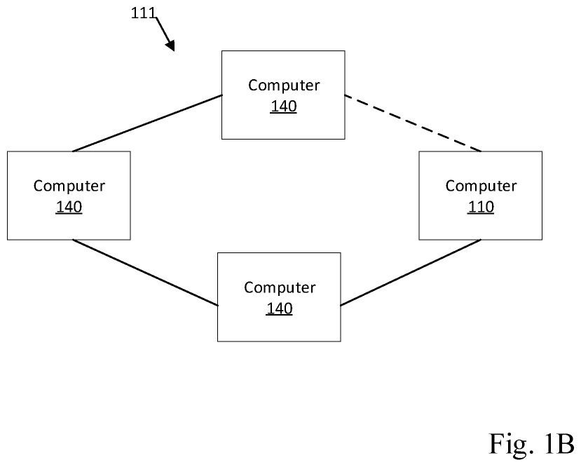

Referring now to FIGS. 1A and 1B, a plurality of computers 110, 140 can generate and maintain a blockchain ledger 150 for managing access to programming instructions for specified vehicle 105 operations. The plurality of computers 110, 140 are communicatively coupled to one another in a blockchain network 111. For example, the computers 110, 140 may be included in computing devices 140 remote from, i.e., external to, a vehicle 105 and a vehicle computer 110. The blockchain network 111 includes distributed computers 110, 140 as a peer-to-peer network that could also include a supervisory computer. The computers 110, 140 authorized to participate in the blockchain network 111 are listed in the blockchain ledger 150.

In this document, the term “network” in the context of a blockchain network 111 means a network formed by computers 110, 140, i.e., a blockchain network 111 means the computers 110, 140 that form the blockchain, including links to each other computers 110, 140. On the other hand, a “network” in the context of devices communicating with each other, e.g., ECUs and/or devices communicating via a vehicle network and/or wide area network 135, means a physical wired and/or wireless network comprising conventional networking hardware, media, protocols, etc.

Each computer 110, 140 may include programming instructions to provide a proof of work for participating as a computer in a blockchain maintenance group. A proof of work is one example of a consensus algorithm, which is used to achieve agreement on data shared among multiple entities. A proof of work is a requirement that a computation, typically requiring extensive computational resources (i.e., significant processing power and/or significant processing time), be performed as a prerequisite to proceeding with a computational task, e.g., performing a transaction (e.g., adding a block to a blockchain ledger 150). As an example, a proof of work may be a requirement to identify a number that, when added to a block of data, modifies the data such that a hash of the data has a specific quality, such as a number of leading zeros. Providing proof of work may include responding to a request from the blockchain maintenance group. The request may include, for example, a data block to be modified, a hash function to be used to generate the hash of the data block and the specific result required from the proof of work. Additionally, or alternatively, performing proof of work may include solving other types of digital puzzles requiring extensive computational resources.

Programming instructions for specified vehicle 105 operations can be stored as data blocks in the blockchain ledger 150. The blockchain ledger 150 is one example of an electronic ledger. An electronic ledger is a distributed database. “Distributed” in this context means that copies of the database are maintained by multiple entities with access to the electronic ledger, e.g., to verify data on the ledger, to store data to the ledger, etc. The data blocks stored within the blockchain ledger are linked in chains by hashes.

Programming instructions for specified vehicle 105 operations are different than programming instructions for general vehicle 105 operations. The vehicle computer 110, under normal operating conditions, stores, e.g., in a memory, programming instructions for general vehicle 105 operations. General vehicle 105 operations are operations that can be performed by vehicle computers in similar vehicles, e.g., based on a vehicle type, make, model, etc. Specified vehicle 105 operations are operations that can be performed only by authorized vehicle computers, i.e., vehicle computers that are authorized to access the programming instructions for the specified vehicle 105 operations. A vehicle computer 110 is authorized to access programming instructions for specified vehicle 105 operations based on the vehicle computer 110 storing, e.g., in a memory, a nonfungible token (NFT) associated with the programming instructions, as discussed further below. Programming instructions for specified vehicle 105 operations may be specified by an entity maintaining a remote computer 140 on the blockchain network 111, e.g., a vehicle 105 and/or component 125 manufacturer.

In this context, a “nonfungible token” is data that represents the programming instructions a computer is authorized to use and is transferrable on a blockchain. The computers 110, 140 can store, e.g., in respective memories, the NFTs and can transmit the NFTs to other computers 110, 140. The NFTs may include respective token identifiers. In this context, a “token identifier” is an alphanumeric string of data that corresponds to an NFT. That is, the token identifier identifies the specific NFT.

The programming instructions for specified vehicle 105 operations may, for example, instruct the vehicle computer 110 to actuate a vehicle component 125, e.g., a suspension component, a braking component, a steering component, etc., based on vehicle parameters specified by the programming instructions. That is, the vehicle parameters specified by the programming instructions are different than the vehicle parameters for general vehicle 105 operations. Generally, a vehicle parameter is a limit of a measurement of a physical characteristic of a vehicle or an environment around that vehicle. More specifically, a vehicle parameter herein is a physical limit of vehicle operation, i.e., a vehicle parameter is a value that specifies a physical quantity providing a limit of a measurement of vehicle operation and/or a measurement of an environmental condition limiting vehicle operation.

The programming instructions for specified vehicle 105 operations may further specify data, e.g., audio data, video data, image data, etc., to be output to a user of the vehicle 105. That is, the programming instructions may instruct the vehicle computer 110 to actuate a vehicle component 125 to output the specified data. For example, the programming instructions may instruct the vehicle computer 110 to actuate a projector in the vehicle 105 to project image data specified by the programming instructions. As another example, the programming instructions may instruct the vehicle computer 110 to actuate a speaker in the vehicle 105 to output audio data specified by the programming instructions. As yet another example, the programming instructions may instruct the vehicle computer 110 to actuate a display in the vehicle 105 to display a set of display content specified by the programming instructions. In the context of this document, a set of display content is a representation of a vehicle system, e.g., a navigation system, an audio system, a climate control system, etc. A set of display content can include one or more content items, i.e., one or more representations of an item to accept a user input or provide a user output. For example, a representation of a control on a touchscreen, such as a knob, slider, button, etc., is a content item that can be included in a set of display content.

Additionally, or alternatively, the programming instructions may instruct the vehicle computer 110 to transition a vehicle component 125 from a disabled state to an enabled state, e.g., to output audio and/or visual data specified by the programming instructions. In other words, upon accessing the programming instructions, the vehicle computer 110 can enable a specified vehicle component 125, e.g., a projector, a speaker, a display, etc., to output data specified by the programming instructions to a user. That is, the programming instructions for general vehicle 105 operations may instruct the vehicle computer 110 to maintain the vehicle component 125 in a disabled state, i.e., to prevent the vehicle component 125 from outputting data to a user.

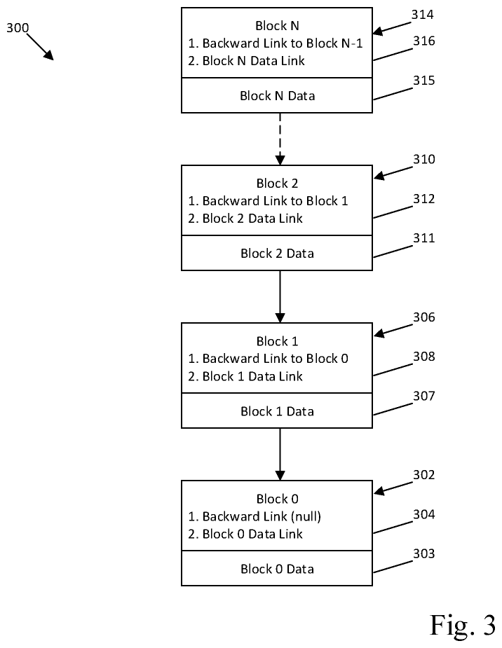

A blockchain ledger 150 is an electronic ledger maintained in each of a plurality of the computers 110, 140 that form the blockchain network 111, each storing shared data based on generation of hashes for blocks of data. A hash in the present context is a one-way encryption of data, i.e., a result of executing a hash function, having a fixed number of bits. An example of hash encryption is SHA-256. The hashes, i.e., results of hash functions, provide links to blocks of data by identifying locations of the block of data in storage (digital memory), for example by use of an association table mapping hashes to respective storage locations. An association table provides a mechanism for associating the hash (which may also be referred to as a hash key) with an address specifying a physical storage device either in a vehicle or a stationary location. The hash for the block of data further provides a code to verify the data to which the hash links. Upon retrieving the block of data, a computer can recompute the hash of the block of data and compare the resulting hash with the hash providing the link. In the case that the recomputed hash matches the linking hash, the computer can determine that the block of data is unchanged. Conversely, a recomputed hash that does not match the linking hash indicates that the block of data or the hash has been changed, for example, through corruption or tampering. The hash providing the link to a block of data may also be referred to as a key or a hash key. An example structure of a blockchain ledger 150 is discussed below in reference to FIG. 3.

FIG. 1A is a block diagram of an example system 100 that includes an instance of a blockchain ledger 150 hosted on at least one remote computer 140 and a vehicle computer 110. The computers 110, 140 are programmed to store an electronic ledger, e.g., a blockchain ledger 150, that specifies an NFT, programming instructions with the NFT, and a vehicle identifier associated with the NFT. The vehicle computer 110 is programmed to, upon transitioning a vehicle 105 to an on state, query the electronic ledger to identify the programming instructions based on the NFT. The vehicle computer 110 is further programmed to, upon retrieving the identified programming instructions from the electronic ledger, actuate the vehicle 105 based on the retrieved programming instructions. The remote computer is programmed to permit the vehicle computer 110 to access the programming instructions based on the vehicle identifier. The electronic ledger is a distributed electronic ledger shared between at least the vehicle computer 110 and the remote computer 140.

The vehicle 105 includes the vehicle computer 110, sensors 115, actuators 120 to actuate various vehicle components 125, and a vehicle communications module 130. The communications module 130 allows the vehicle computer 110 to communicate with remote computer(s) 140, and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle 110 computer can be a generic computer with a processor and memory as described above, and/or may include an electronic control unit (ECU) or electronic controller or the like for a specific function or set of functions, and/or may include a dedicated electronic circuit including an ASIC that is manufactured for a particular operation, e.g., an ASIC for processing sensor data and/or communicating the sensor data. In another example, the vehicle computer may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed- signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 110.

The vehicle computer 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicle 105 propulsion, braking, and steering; in a non-autonomous mode a human operator controls each of vehicle 105 propulsion, braking, and steering.

The vehicle computer 110 may include programming to operate one or more of vehicle brakes, propulsion (e.g., control of acceleration in the vehicle by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communications network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices, e.g., sensors 115, actuators 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known, e.g., Light Detection And Ranging (LIDAR) sensor(s), radar sensors, camera sensors, etc. to provide data to the vehicle computer 110.

The vehicle 105 actuators 120 are implemented via circuits, chips, or other electronic and or mechanical components that can actuate various vehicle 105 subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle, slowing or stopping the vehicle, steering the vehicle, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the vehicle computer 110 may be configured for communicating via a vehicle-to-vehicle communication module 130 or interface with devices outside of the vehicle, e.g., through a vehicle-to-vehicle (V2V) or vehicle-to-infrastructure (V2X) wireless communications (cellular and/or short-range radio communications, etc.) to another vehicle, and/or to a remote computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. For convenience, the label “V2X” is used herein for communications that may be vehicle-to-vehicle (V2V) and/or vehicle-to-infrastructure (V2I), and that may be provided by communications module 130 according to any suitable short-range communications mechanism, e.g., DSRC, cellular, or the like.

The network 135 represents one or more mechanisms by which a vehicle computer 110 may communicate with remote computing devices, e.g., the remote computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The blockchain network 111 (as shown in FIG. 1B) includes the plurality of computers 110, 140, i.e., in a peer-to-peer network, with each computer 110, 140 in the peer-to-peer network including links to other computers 110, 140 in the blockchain network 111. Computers 110, 140 in the blockchain network 111 may be specified by, e.g., the vehicle 105 owner, the vehicle 105 manufacturer, etc., and may be recorded in the blockchain ledger 150.

The blockchain ledger 150 is a distributed blockchain ledger. That is, each computer 110, 140 stores, e.g., in a memory, one copy of the blockchain ledger 150. The computers 110, 140 may, for example, receive data blocks from other computers 110, 140 and may upload the data blocks to their respective copies of the blockchain ledger 150, i.e., store the respective data blocks in respective storage locations in their respective blockchain ledgers 150 such that each data block is linked to one respective previous data block. Each data block may specify programming instructions and a nonfungible token associated with the programming instructions. The data blocks may be generated based on requests, which may be submitted, for example, by one of the computers 110, 140. Each computer 110, 140 can compare its stored blockchain data, i.e., linked data blocks, to versions of the blockchain ledger 150 stored by other computers 110, 140 to verify the data blocks. For example, each computer 110, 140 can generate a hash based on the data stored in a respective data block of a blockchain stored by another computer 110, 140. In the case the hash generated by the one computer 110, 140 matches the hash stored by the other computers 110, 140 for the respective data block, the one computer 110, 140 determines the data block is verified.

The plurality of computers 110, 140 maintains the blockchain ledger 150. That is, the plurality of computers 110, 140 may receive requests from time-to-time to add a computer to the plurality of computers 110, 140. The computer may be, for example, a computer hosted on a remote computing device 140. In the present context, “remote computing device” means that the computer device is not installed on the vehicle 105. That is, the vehicle 105 can move separately from the computing device. The computers in the plurality of computers 110, 140 evaluate the request, as described below. In case that the request is approved, the plurality of computers 110, 140 adds the computer to the plurality of computers 110, 140 and adds a data block to the blockchain ledger 150 recording the addition of a computer, i.e., a new node, to the blockchain ledger 150.

Additionally, or alternatively, the plurality of computers 110, 140 may receive requests for a vehicle computer 110 to access programming instructions. The computers 110, 140 evaluate the request, as described below. In the event that the request is approved, the plurality of computers 110, 140 adds a data block to the blockchain ledger 150 recording the vehicle computer 110 accessing the programming instructions. Additionally, or alternatively, the plurality of computers 110, 140 may receive requests for one computer 110, 140 to transfer an NFT to another computer 110, 140. The computers 110, 140 evaluate the request, as described below. In the case that the request is approved, the plurality of computers 110, 140 adds a data block to the blockchain ledger 150 recording the transfer.

Each computer 110, 140 stores one copy of the blockchain ledger 150. The computers 110, 140 can be accessed via the communications network. The computers 110, 140 may be associated with an entity that participates in maintaining the blockchain ledger 150, e.g., to verify data in the blockchain ledger 150, to store data on the blockchain ledger 150, etc. For example, a computer may be hosted on the vehicle computer 110 and remote computing devices 140.

A remote computer 140 can be a conventional computing device, i.e., including one or more processors and one or more memories, programmed to provide operations such as disclosed herein. Further, the remote computers 140 can be accessed via the network, e.g., the Internet, a cellular network, and/or or some other wide area network. The remote computers 140 are maintained by respective entities other than the vehicle 105, e.g., a vehicle 105 manufacturer, a component 125 manufacturer, a vehicle 105 dealership, another vehicle, etc.

The remote computers 140 may store, e.g., in a respective memory, respective entity identifiers that identifies the entity maintaining the corresponding remote computer 140. In this context, an “entity identifier” is an alphanumeric string of data that corresponds to the entity. That is, the entity identifier identifies the specific entity.

At least one remote computer 140 is programmed to provide programming instructions to the blockchain ledger 150. For example, the respective remote computer 140 may receive a user input, e.g., via an interface, specifying the programming instructions and one or more NFTs associated with the programming instructions. The respective remote computer 140 then transmits the programming instructions, the NFT(s), and the respective entity identifier to the other computers 110, 140.

Upon receiving the transmission of this data for a remote computer 140, respective receiving computers 110, 140 can evaluate the transmission based on the entity identifier. For example, the blockchain ledger 150 may store one or more authorized identifiers that specifies respective entities authorized to provide programming instructions. In the case that the transmitted entity identifier matches an authorized identifier stored in the blockchain ledger 150, the plurality of computers 110, 140 can authorize the transmission and store the programming instructions and the NFT(s) to the blockchain ledger 150. In this situation, the blockchain ledger 150 records the NFT(s) as being associated with the programming instructions and the entity identifier specified by the respective remote computer 140. In the case that the transmitted entity identifier does not match an authorized identifier stored in the blockchain ledger 150, the plurality of computers 110, 140 ignore the transmission, i.e., do not store the transmitted programming instructions or the NFT(s) to the blockchain ledger 150.

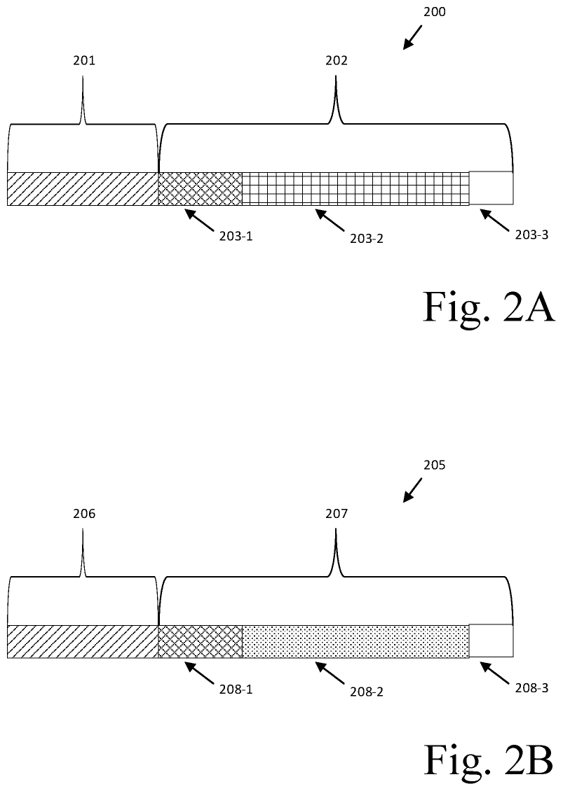

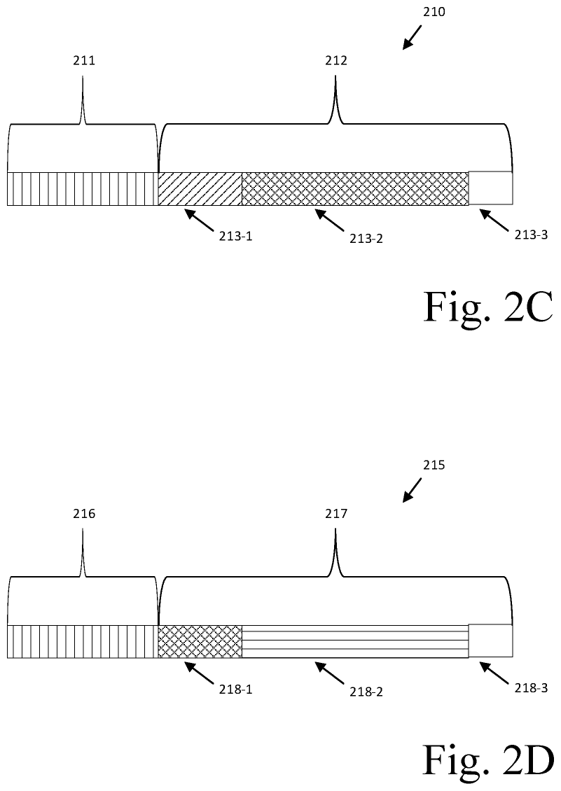

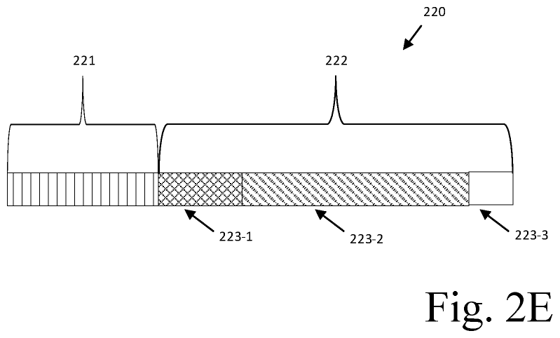

As set forth above, the computers 110, 140 can be programmed to transfer the NFTs to other computers 110, 140. As one example, a remote computer 140 can transmit an NFT to a vehicle computer 110. For example, the remote computer 140 can receive a request message 210 (described below; see FIG. 2C), from the vehicle computer 110, to transfer the NFT to the vehicle computer 110. Upon receiving the request message 210, the remote computer 140 can access data in the request message 210, e.g., a specified payload segment 213 of a payload 212 of the request message 210, and retrieve a token identifier from the request message 210. The remote computer 140 can query the blockchain ledger 150 to identify one or more NFT(s) associated with the entity identifier stored on the blockchain ledger 150. The remote computer 140 can then compare the retrieved token identifier to the stored token identifier(s) for the NFT(s) associated with the entity identifier in the blockchain ledger 150. If the retrieved token identifier matches a stored token identifier, then the remote computer 140 can verify that the requested NFT is associated with the entity identifier. If the retrieved token identifier does not match a stored token identifier, then the remote computer 140 can verify that the requested NFT is not associated with the entity identifier.

Upon verifying that the requested NFT is associated with the entity identifier, the remote computer 140 can generate a response message 200. A response message 200 includes a header 201 and a payload 202 (see FIG. 2A). The header 201 of the response message 200 may include a message type, a message size, the entity identifier, etc. The payload 202 may include various data, i.e., message content. The payload 202 can include sub-payloads or payload segments 203-1, 203-2, 203-3 (collectively, referred to as payload segments 203). The respective payload segments 203 in FIG. 2A are illustrated as being of different lengths to reflect that different payload segments 203 may include various amount of data, and therefore may be of different sizes, i.e., lengths. For example, the remote computer 140 can include an instruction to transfer a specified number of fungible tokens from the vehicle computer 110 in, e.g., a specified payload segment 203 of, the payload 202 of the response message 200. Upon generating the response message 200, the remote computer 140 can then provide the response message 200 to the vehicle computer 110. For example, the remote computer 140 can transmit the response message 200 to the vehicle computer 110, e.g., via the blockchain network 111, the network 135, V2V communications, etc.

In the present context, a “fungible token” is data that represents a number of units of an object and is transferrable on the blockchain. The unit can be, for example, a unit of currency money, e.g., 0.01 cents, 0.1 cents, 1 cent, a unit of virtual currency (or faction thereof), etc., an amount of an object, e.g., size or weight, of a raw material object, e.g., 1 gram of gold or silver, 1 foot of lumber, etc. The computers 110, 140 can store, e.g., in respective memories, the fungible tokens and can transmit the fungible tokens to other computers 110, 140.

Upon providing the response message 200, the remote computer 140 can detect a transfer message 215 (described below) from the vehicle computer 110. For example, the remote computer 140 can be programmed to monitor the blockchain network 111 for the transfer message 215. The remote computer 140 can, for example, access, e.g., a specified payload segment 218 of, a payload 217 of the transfer message 215 and retrieve a number of fungible tokens transferred from the vehicle computer 110. The remote computer 140 can then compare the number of retrieved fungible tokens to the specified number of fungible tokens in the response message 200.

If the number of retrieved fungible tokens is less than the specified number of fungible tokens, then the remote computer 140 can reject the transfer message 215. For example, the remote computer 140 can determine to not store the fungible tokens included in the transfer message 215. Additionally, the remote computer 140 can determine to not transmit the NFT to the vehicle computer 110. In other words, the remote computer 140 can ignore the request to transfer the NFT to the vehicle computer 110 based on the number of retrieved fungible tokens being less than the number of specified fungible tokens in the response message 200.

If the number of retrieved fungible tokens is equal to the specified number of fungible tokens, then the remote computer 140 can accept the transfer message 215. In this situation, the remote computer 140 can be programmed to request to record a record in the blockchain ledger 150 indicating the transfer of the NFT from the remote computer 140 to the vehicle computer 110. That is, the record specifies that the NFT is associated with the vehicle identifier. The remote computer 140 can, for example, access a header 216 of the transfer message 215 and retrieve the vehicle identifier. In this context, a “vehicle identifier” is an alphanumeric string of data that corresponds to the vehicle 105 maintaining the vehicle computer 110. That is, the vehicle identifier identifies the specific vehicle 105.

To request to record the record in the blockchain ledger 150, the remote computer 140 can transmit the token identifier of the NFT, the vehicle identifier, the specified number of fungible tokens, and the entity identifier to the other computers 110, 140. Upon receiving the transmission, the plurality of computers 110, 140 evaluates the transmission based on the entity identifier. For example, the blockchain ledger 150 may store a record indicating that the NFT is associated with an entity identifier. In the case that the transmitted entity identifier matches the entity identifier stored in the blockchain ledger 150, the plurality of computers 110, 140 authorize the transfer and store the record indicating that the NFT is associated with the vehicle identifier to the blockchain ledger 150. In the case that the transmitted entity identifier does not match the entity identifier stored in the blockchain ledger, the plurality of computers 110, 140 can reject the transfer, i.e., can maintain the record in the blockchain ledger 150 indicating that the NFT is associated with the entity identifier.

Upon the plurality of computers 110, 140 authorizing the transfer, the remote computer 140 can store the number of retrieved fungible tokens, e.g., in a memory of the remote computer 140. Additionally, the remote computer 140 can generate an authorization message 205. Similar to the response message 200, the authorization message 205 includes a header 206 and a payload 207, including payload segments 208 (see FIG. 2B). The header 206 of the authorization message 205 may include a message type, a message size, the entity identifier, etc. The payload 207 may include various data, i.e., message content. The remote computer 140 can include the NFT in, e.g., a specified payload segment 208 of, the payload 207 of the authorization message 205. The remote computer 140 can then provide the authorization message 205 to the vehicle computer 110, e.g., in substantially the same manner as discussed above regarding providing the response message 200 to the vehicle computer 110. Additionally, or alternatively, the vehicle computer 110 can transmit an NFT to a remote computer 140, e.g., in substantially the same manner as discussed above.

The vehicle computer 110 can be programmed to request a transfer of an NFT from a remote computer 140. For example, the vehicle computer 110 can actuate a human-machine interface (HMI) to detect a user input selecting a representation of an NFT. For example, the HMI may be programmed to display a virtual button on a touchscreen display that the user can select to select the representation. In this situation, the HMI may activate sensors 115 that can detect the user selecting the virtual button to select the representation. Upon detecting the first user input, the HMI can then provide the first user input to the vehicle computer 110, and the vehicle computer 110 can generate a request message 210 based on the user input.

Similar to the response message 200, the request message 210 includes a header 211 and a payload 212, including payload segments 213 (see FIG. 2C). The header 211 of the request message 210 may include a message type, a message size, a vehicle identifier, etc. The payload 212 may include various data, i.e., message content. The vehicle computer 110 can include a request to transfer an NFT and a token identifier for the NFT in, e.g., a specified payload segment 213 of, the payload 212 of the request message 210. The vehicle computer 110 can then provide the request message 210 to the remote computer 140, e.g., in substantially the same manner as discussed above regarding providing the response message 200 to the vehicle computer 110.

Upon providing the request message 210, the vehicle computer 110 can detect the response message 200. For example, the vehicle computer 110 can be programmed to monitor the blockchain network 111 for the response message 200. The vehicle computer 110 can access, e.g., a specified payload segment 203 of, the payload 202 of the response message 200 to determine a specified number of fungible tokens. The vehicle computer 110 can then compare the specified number of fungible tokens to a number of fungible tokens stored, e.g., in a memory of the vehicle computer 110. If the specified number of fungible tokens is greater than the stored number of fungible tokens, then the vehicle computer 110 can output a message to a user, e.g., via the HMI, indicating the NFT will not be transferred to the vehicle computer 110 based on the number of stored number of fungible tokens being less than the specified number of fungible tokens. If the specified number of fungible tokens is less than or equal to the stored number of fungible tokens, then the vehicle computer 110 can generate the transfer message 215. Alternatively, the vehicle computer 110 can actuate the HMI to request authorization, e.g., via a second user input, prior to generating the transfer message 215.

Similar to the response message 200, the transfer message 215 includes a header 216 and a payload 217, including payload segments 218 (see FIG. 2D). The header 216 of the transfer message 215 may include a message type, a message size, a vehicle identifier, etc. The payload 217 may include various data, i.e., message content. The vehicle computer 110 can include the specified number of fungible tokens in, e.g., a specified payload segment 218 of, the payload 217 of the transfer message 215. The vehicle computer 110 can then provide the transfer message 215 to the remote computer 140, e.g., in substantially the same manner as discussed above regarding providing the response message 200 to the vehicle computer 110.

Upon providing the transfer message 215, the vehicle computer 110 can detect the authorization message 205. For example, the vehicle computer 110 can be programmed to monitor the blockchain network 111 for the authorization message 205. The vehicle computer 110 can access data in the transfer message 215, e.g., a specified payload segment 208 of the payload 207 of the authorization message 205, to retrieve the requested NFT. The vehicle computer 110 can then store, e.g., in a memory of the vehicle computer 110, the NFT. Additionally, or alternatively, the remote computer 140 can request an NFT from a vehicle computer 110, e.g., in substantially the same manner as discussed above.

The vehicle computer 110 is typically programmed to manage startup and shutdown of the vehicle 105. For example, the vehicle computer 110 can startup or shutdown the vehicle 105 based on receiving a request from, e.g., a remote computer 140, user input to a power or start/stop button or the like in a passenger cabin of the vehicle 105, a key turning an ignition, etc. That is, the vehicle computer 110 can transition the vehicle 105 between an off state and an on state. In the on state, substantially all vehicle components 125 are available to be actuated by the vehicle computer 110 to operate the vehicle 105. In the off state, the vehicle computer 110 and components 125 are substantially powered off to conserve energy when the vehicle 105 is not in use.

A power supply provides electricity to one or more components 125. The power supply can include one or more batteries, e.g., 12-volt lithium-ion batteries, and one or more power networks to supply power from the batteries to the components 125. In the on state, the power supply provides power to substantially all of the vehicle components 125. For example, in the on state, the power supply can provide power to the vehicle components 125 that are in an enabled state. That is, in the on state, the power supply may not provide power to vehicle components 125 that are in a disabled state. In the off state, the power supply does not provide power to the vehicle components 125. The power supply can provide power to the vehicle computer 110 in the on state and the off state.

When the vehicle 105 transitions to the ON state, the vehicle computer 110 queries the blockchain ledger 150 to identify programming instructions stored in the blockchain ledger 150 that are associated with the vehicle 105. The vehicle computer 110 can access a memory of the vehicle computer 110 and determine a token identifier for an NFT stored in the memory. Additionally, the vehicle computer 110 can access a record in the blockchain ledger 150 and can identify programming instructions and a token identifier of an NFT associated with the programming instructions stored in the record of the blockchain ledger 150. The vehicle computer 110 can then compare the token identifier stored in the memory to the token identifier stored in the blockchain ledger 150. If the token identifier stored in the blockchain ledger 150 matches the token identifier stored in the memory, i.e., identifies the stored NFT, then the vehicle computer 110 identifies the programming instructions as being associated with the vehicle 105. If the token identifier in the stored blockchain ledger 150 does not matches the token identifier stored in the memory, i.e., does not identify the stored NFT, then the vehicle computer 110 identifies the programming instructions as not being associated with the vehicle 105. The vehicle computer 110 can continue to query the blockchain ledger 150 in this manner until the vehicle computer 110 identifies programming instructions for respective NFTs stored by the vehicle computer 110, e.g., in a memory, or the vehicle computer 110 queries all the records of the blockchain ledger 150.

Upon identifying program instructions associated with the vehicle 105, the vehicle computer 110 can generate an access message 220. Similar to the response message 200, the access message 220 includes a header 221 and a payload 222, including payload segments 223 (see FIG. 2E). The header 221 of the access message 220 may include a message type, a message size, a vehicle identifier, etc. The payload 222 may include various data, i.e., message content. The vehicle computer 110 can include a request to access the programming instructions and the token identifier of the NFT in, e.g., a specified payload segment 223 of, the payload 222 of the access message 220. The vehicle computer 110 can then provide the access message 220 to the plurality of computers 110, 140, e.g., in substantially the same manner as discussed above.

The computers 110, 140 are programmed to output acceptance or rejection of the access message 220. A computer 110, 140 can determine whether a majority of the computers in the plurality of computers 110, 140 accepted or rejected the access message, i.e., can execute a consensus protocol. As one example, the determination may be based on a weighted majority, i.e., a proof of stake, wherein each of the computers 110, 140 are assigned weights. Each computer 110, 140 may be allotted a predetermined weight (for example, stored in memory by the device manufacturer, or for aftermarket devices, stored in memory when the aftermarket device is added to the blockchain ledger 150). The weight may be predetermined, for example, based on the entity associated with the computer 110, 140. In such an example, a computing device 110, 140 associated with the vehicle manufacturer may have a higher predetermined weight than a computing device 110, 140 associated with another entity. Alternatively, the result of the determination of acceptance or rejection of an access message 220 may be based on any suitable consensus protocol or algorithm, e.g., proof of burn, proof of elapsed time, proof of capacity, proof of activity, etc.

The computers 110, 140 may evaluate the access message 220 and determine whether to accept or reject the access message 220. The computers 110, 140 perform the evaluation based on one or more criteria. One criterion may be whether a vehicle identifier and a token identifier for an NFT included in the access message 220 matches a vehicle identifier and a token identifier for an NFT associated with the vehicle identifier stored in the blockchain ledger 150. For example, the computers 110, 140 may query the respective copies of the blockchain ledger 150 to determine the vehicle 105 is authorized to access the programming instructions. For example, the computers 110, 140 may determine the vehicle 105 is authorized to access the programming instructions based on the vehicle identifier and the token identifier for the NFT matching a vehicle identifier and a token identifier for an NFT associated with the vehicle identifier stored in each copy of the blockchain ledger 150, i.e., meeting parameters stored in the blockchain ledger 150 for the vehicle 105. In this situation, the computers 110, 140 permit the vehicle computer 110 to access the programming instructions associated with the NFT stored in the blockchain ledger 150. That is, the vehicle computer 110 can retrieve the programming instructions associated with the NFT from the blockchain ledger 150. In this situation, the vehicle computer 110 can then actuate one or more vehicle components 125 based on the retrieved programming instructions, as discussed above.

Conversely, the computers 110, 140 may determine the vehicle 105 is not authorized to access the programming instructions based on one of the vehicle identifier or the token identifier not matching a vehicle identifier or a token identifier for an NFT associated with the vehicle identifier stored in each copy of the blockchain ledger 150, i.e., not meeting one or more parameters stored in the blockchain ledger 150 for the vehicle 105. In this situation, the computers 110, 140 prevent the vehicle computer 110 from accessing the programming instructions associated with the NFT.

FIG. 3 is an example of a blockchain 300 such as may be used for the blockchain ledger 150. The blockchain 300 includes a zero data block 302, a first data block 306, a second data block 310 and a nth data block 314. The blocks are organized in a chain. The zero data block 302 is at a first, beginning end of the chain. The first data block 306 is linked to the zero data block 302. The second data block 310 is linked to the first data block 306. Each successive data block is linked to the previous data block. The nth data block 314, at a second end of the chain, is linked to the (n-1)th data block (not shown).

Each block includes a data portion and a linking portion as shown in Table 1.

| Data Block | Data Portion | Linking Portion |
|---|---|---|
| 302 | 303 | 304 |
| 306 | 307 | 308 |
| 310 | 311 | 312 |
| 314 | 315 | 316 |

The data portion 303, 307, 311, 316 includes data to be stored in the data block. The linking portion 304, 308, 312, 316 includes a link to the data portion 303, 307, 311, 316, and, except for the zero data block, includes a link to the previous data block in the chain. For example, in the first data block 306, the data portion 307 stores data. The linking portion 308 includes a link “block 1 data link” that provides a link to the data portion 307. The linking portion 308 further includes a link “backward link to block 0” that provides a link to the linking portion of data block 0.

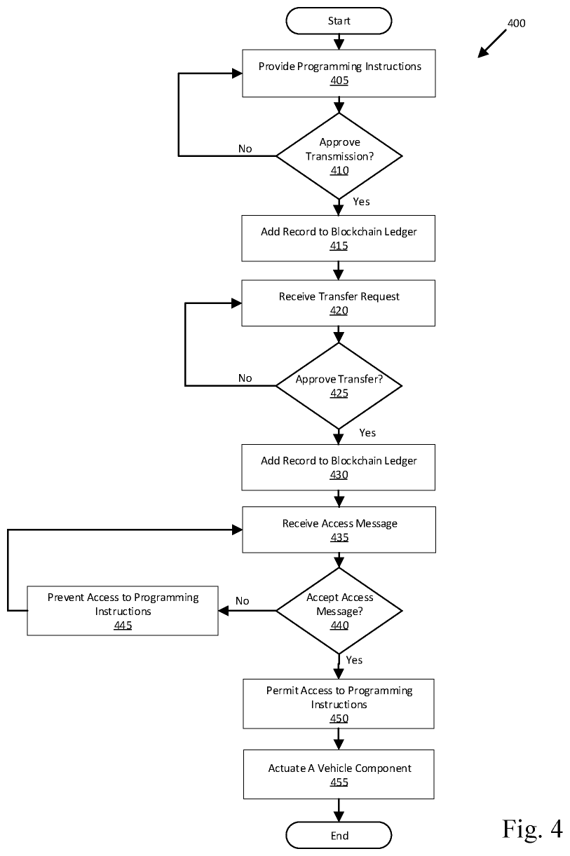

FIG. 4 is a diagram of an example process 400 executed in a plurality of computers 110, 140 according to program instructions stored in a respective memories thereof for controlling access to programming instructions via a blockchain ledger 150.

The process 400 begins in a block 405. In the block 405, a remote computer 140 provides programming instructions and NFTs associated with the programming instructions. For example, a user can input the programming instructions and the associated NFTs to the remote computer 140, e.g., via an interface, and the remote computer 140 can transmit data indicating the programming instructions and the associated NFTs to each computer 110, 140, e.g., via the blockchain network 111. Additionally, the remote computer 140 can transmit an entity identifier associated with the NFTs to each computer 110, 140, e.g., via the blockchain network 111. The programming instructions specify vehicle operations, as discussed above. The process 400 continues in a block 410.

In the block 410, the computers 110, 140 determine whether to approve the transmission specifying the programming instructions and the associated NFTs. The computers 110, 140 can determine to approve the transmission based on the entity identifier matching an authorized entity identifier stored in the blockchain ledger 150, as discussed above. Conversely, the computers 110, 140 can determine to reject the transmission based on the entity identifier not matching an authorized entity identifier stored in the blockchain ledger 150, as discussed above. If the computers 110, 140 approve the transmission, then the process 400 continues in a block 415. Otherwise, the process 400 returns to the block 405.

In the block 415, the computers 110, 140 add a record to the blockchain ledger 150. The record includes the programming instructions and the NFTs associated with the programming instructions. That is, the programming instructions and the NFTs are stored to the blockchain ledger 150. Additionally, the record specifies the entity identifier associated with the NFTs. The process 400 continues in a block 420.

In the block 420, the computers 110, 140 receive a request to transfer an NFT from one computer to another computer. The one computer can generate and provide a request message 210 to transfer the NFT, as discussed above. The other computer can then, e.g., upon determining a number of fungible tokens received from the one computer equals a number of requested fungible tokens, transmit an identifier for the entity maintaining the other computer, the token identifier, and an identifier for the entity maintaining the one computer to the computers 110, 140, as discussed above. The process 400 continues in a block 425.

In the block 425, the computers 110, 140 determine whether to approve the transfer. The computers 110, 140 can determine to approve the transmission based on the entity (or vehicle) identifier matching an entity (or vehicle) identifier associated with the NFT in the blockchain ledger 150, as discussed above. Conversely, the computers 110, 140 can determine to reject the transfer based on the entity (or vehicle) identifier not matching an entity (or vehicle) identifier associated with the NFT in the blockchain ledger 150, as discussed above. If the computers 110, 140 approve the transfer, then the process 400 continues in a block 430. Otherwise, the process 400 returns to the block 420.

In the block 430, the computers 110, 140 add a record to the blockchain ledger 150. The record specifies the transfer of the NFT from the one computer to the other computer. That is, the record specifies the identifier for the entity maintaining the other computer as being associated with the NFT. The process 400 continues in a block 435.

In the block 435, the computers 110, 140 receive a request to access programming instructions from a vehicle computer 110. Upon transitioning a vehicle 105 to an on state, the vehicle computer 110 can access a memory to determine a token identifier for an NFT stored in the memory, as discussed above. The vehicle computer 110 can then query a respective copy of the blockchain ledger 150 to determine programming instructions associated with the NFT based on the token identifier, as discussed above. The vehicle computer 110 can provide an access message 220 to each computer 110, 140, e.g., via the blockchain network 111. The access message 220 includes the vehicle identifier, the token identifier, and a request for permission to retrieve the programming instructions associated with the NFT specified by the token identifier. The process 400 continues in a block 440.

In the block 440, the computers 110, 140 vote to accept or reject the access message 220 based on determining whether the vehicle identifier and the token identifier are associated with each other in the blockchain ledger 150, as discussed above. If the computers 110, 140 accept the access message 220, then the process 400 continues in a block 350. Otherwise, the process 400 continues in a block 445.

In the block 445, the computers 110, 140 prevent the vehicle computer 110 from accessing the programming instructions. The process 400 returns to the block 435.

In the block 450, the computers 110, 140 permit the vehicle computer 110 to retrieve the programming instructions. Additionally, the computers 110, 140 add a record to the blockchain ledger 150 specifying the vehicle computer 110 retrieved the programming instructions. The process 400 continues in a block 455.

In the block 455, the vehicle computer 110 operates the vehicle 105 based on the retrieved programming instructions. For example, the vehicle computer 110 may actuate one or more vehicle components 125 based on vehicle parameters specified by the retrieved programming instructions, as discussed above. As another example, the vehicle computer 110 may actuate one or more vehicle components 125 to output specified data, e.g., a set of display content, to a user, as discussed above. As yet another example, the vehicle computer 110 may transition one or more vehicle components 125 from a disabled state to an enabled state according to the retrieved programming instructions, as discussed above. The process 400 ends following the block 455.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer including a processor and a memory, the memory storing instructions executable by the processor to:
store a vehicle identifier and a nonfungible token (NFT) associated with the vehicle identifier on an electronic ledger, wherein the electronic ledger is a distributed electronic ledger shared between at least the computer and a remote computer;
upon transitioning a vehicle to an on state, query the electronic ledger to identify programming instructions associated with the NFT; and
upon retrieving the identified programming instructions from the electronic ledger, actuate the vehicle based on the retrieved programming instructions.

2. The system of claim 1, further comprising the remote computer, including a second processor and a second memory storing instructions executable by the second processor such that the remote computer is programmed to:
store the programming instructions associated with the NFT to the electronic ledger;
upon determining that the vehicle identifier is associated with the NFT, permit the computer to access the programming instructions associated with the NFT; and
upon determining that the vehicle identifier is not associated with the NFT, prevent the computer from accessing the programming instructions associated with the NFT.

3. The system of claim 2, wherein the remote computer is further programmed to:
record in the electronic ledger a record that the NFT is transferred from the vehicle to another entity; and
upon recording the record, prevent the vehicle from accessing the programming instructions associated with the NFT.

4. The system of claim 3, wherein the record includes a request, from the other entity, for the NFT and a confirmation, from the computer, indicating that the NFT is transferred to the other entity.

5. The system of claim 2, wherein the remote computer is further programmed to:
record in the electronic ledger a record that the NFT is transferred from another entity to the vehicle; and
upon recording the record, allow the vehicle to access the programming instructions associated with the NFT.

6. The system of claim 1, wherein the programming instructions include instructions to transition a vehicle component associated with the NFT between a disabled state and an enabled state.

7. The system of claim 1, wherein the programming instructions include instructions to actuate a projector in the vehicle to project image data associated with the NFT.

8. The system of claim 1, wherein the programming instructions include instructions to actuate a speaker in the vehicle to provide sound data associated with the NFT.

9. The system of claim 1, wherein the programming instructions include instructions to actuate a display in the vehicle to display a set of display content associated with the NFT.

10. The system of claim 1, wherein the programming instructions include instructions to actuate a vehicle component based on vehicle parameters associated with the NFT.

11. A system, comprising:
a vehicle computer including a processor and a memory, the memory storing instructions such that the vehicle computer is programmed to store a vehicle identifier and a nonfungible token (NFT) on an electronic ledger;
a remote computer including a second processor and a second memory, the second memory storing instructions such that the remote computer is programmed to store programming instructions associated with respective NFTs on the electronic ledger;
wherein the vehicle computer is further programmed to:
upon transitioning a vehicle to an on state, query the electronic ledger to identify programming instructions associated with the NFT; and
upon retrieving the identified programming instructions, actuate the vehicle based on the identified programming instructions.

12. The system of claim 11, wherein the remote computer is further programmed to:
upon determining that the vehicle identifier is associated with the NFT, permit the computer to access the programming instructions associated with the NFT; and
upon determining that the vehicle identifier is not associated with the NFT, prevent the computer from accessing the programming instructions associated with the NFT.

13. The system of claim 11, wherein the remote computer is further programmed to:
record in the electronic ledger a record that the NFT is transferred from the vehicle to another entity; and
upon recording the record, prevent the vehicle from accessing the programming instructions associated with the NFT.

14. The system of claim 11, wherein the remote computer is further programmed to:
record in the electronic ledger a record that the NFT is transferred from another entity to the vehicle; and
upon recording the record, allow the vehicle to access the programming instructions associated with the NFT.

15. The system of claim 11, wherein the programming instructions include instructions to actuate a projector in the vehicle to project image data associated with the NFT.

16. The system of claim 11, wherein the programming instructions include instructions to actuate a projector in the vehicle to project image data associated with the NFT.

17. The system of claim 11, wherein the programming instructions include instructions to actuate a speaker in the vehicle to provide sound data associated with the NFT.

18. The system of claim 11, wherein the programming instructions include instructions to actuate a display in the vehicle to display a set of display content associated with the NFT.

19. The system of claim 11, wherein the programming instructions include instructions to actuate a vehicle component based on vehicle parameters associated with the NFT.

20. A method, comprising:
storing, via a vehicle computer, a vehicle identifier and a nonfungible token (NFT) on an electronic ledger;
storing, via a remote computer, programming instructions associated with respective NFTs on the electronic ledger;
upon transitioning a vehicle to an on state via the vehicle computer, querying the electronic ledger to identify programming instructions associated with the NFT; and
upon retrieving the identified programming instructions, actuating, via the vehicle computer, the vehicle based on the identified programming instructions.
